(19) United States
(12) Patent Application Publication
(10) Pub. No.: US 2004/0094876 A1
(43) Pub. Date: May 20, 2004

(54) Process for preparing a blow molding preform

(76) Inventor: L. Robert Deardurff, Waterville, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/689,357

(22) Filed: Oct. 20, 2003

Related U.S. Application Data
(60) Provisional application No. 60/421,159, filed on Oct. 25, 2002.

(51) Int. Cl. B29C 47/00

(52) U.S. Cl. 264/540; 264/210.1

(57) ABSTRACT

A process for preparing a blow molding preform comprises melting plastic flakes in a plasticizing screw extruder to prepare a homogeneous stream of hot polymer melt at the discharge of the extruder, cooling the polymer melt stream to a temperature at least 20 degrees Centigrade below the extruder discharge temperature by heat exchange with a liquid heat transfer medium, and forming the cooled polymer melt into a blow molding preform.

### CROSS-REFERENCE TO RELATED APPLICATION

This application claims the benefit of U.S. provisional patent application Serial No. 60/421,159, filed Oct. 25, 2002.

### FIELD OF THE INVENTION

The present invention relates generally to a process for preparing a blow molding preform. More particularly, the invention is directed to a process for conditioning the melt polymer stream from an extruder, prior to the injection molding of a blow molding preform.

### BACKGROUND OF THE INVENTION

Conventional blow molding operations, such as those used to produce plastic containers, utilize an extruder to melt and homogenize plastic pellets, to prepare a polymer melt from which a blow molding preform may be produced. The high temperature of the polymer melt often leads to processing difficulties in the manufacture of the blow molding preform and degraded properties in the ultimately-produced blow molded article.

It is known to utilize a reverse heat profile plasticating extruder, wherein the temperatures are hotter at the feed end of the screw and lower at the discharge or metering end of the screw. However, this arrangement often results in inconsistent material feed to the extruder and erratic polymer melt pressure and flow at the outlet.

Often, lower molding machine cycle times are achieved by removing the molded article from the mold prior to optimal cooling when the article may not yet possess the desired solid-state strength. This operation is conventionally followed by an additional cooling operation, adding to the expense of the operation due to the need for a separate cooling station and/or additional sets of cooling molds.

Frequently, in order to increase polymer melt strength, the material is polymerized to a very high molecular weight, or co-monomers are added, or cross-linking agents are employed in the polymer, to increase the polymer melt viscosity. However, each of these operations adds significantly to the cost of the polymer melt, and may cause the ultimately produced article to fall outside FDA guidelines where food contact is necessary.

It would be desirable to provide an improved process for preparing blow molding preforms, wherein said process would not significantly increase processing costs or cycle times.

### SUMMARY OF THE INVENTION

Accordant with the present invention, an improved process for preparing blow molding preforms has surprisingly been discovered. The inventive process comprises: melting polymer flakes in a plasticating screw extruder, to prepare a homogeneous stream of hot polymer melt at the discharge of the extruder; cooling the polymer melt stream to a temperature at least 20 degrees Centigrade below the extruder discharge temperature, by heat exchange with a liquid heat transfer medium; and forming the cooled polymer melt into a blow molding preform.

The process for preparing a blow molding preform according to the present invention is particularly useful for manufacturing preforms for the production of plastic containers.

### DETAILED DESCRIPTION OF THE PREFERRED EMBODIMENT

A process for preparing a blow molding preform comprises melting polymer flakes in a plasticizing screw extruder to prepare a homogeneous stream of hot polymer melt at the discharge of the extruder, cooling the polymer melt stream.to a temperature at least 20 degrees Centigrade below the extruder discharge temperature by heat exchange with a liquid heat transfer medium, and forming the cooled polymer melt into a blow molding preform.

The polymer flakes that are useful in the present invention may comprise any plastic, or combinations, blends, or copolymers of plastics, known to be useful in the blow molding of containers. Suitable examples comprise, but are not necessarily limited to, polyethylene terephthalate (hereinafter, PET), polyolefin, polyester, polyamide, acrylonitrile acid ester, vinyl chloride, and derivatives, blends, and copolymers thereof. A preferred polymer comprises PET.

By the term “polymer flakes” as it is used herein is meant particles of those polymers set-forth above, which are generally commercially available in the form of flakes, chunks, sphere, pellets, and the like, and which are generally made commercially available in bulk in a substantially uniform average mean particle size from about ⅛ inch to about ¾ inch.

The polymer flakes are melted in a conventional plasticizing screw extruder, to prepare a homogeneous stream of hot polymer melt at the extruder discharge. Typically, the temperature of the polymer melt stream discharged from the extruder ranges from about 225 degrees Centigrade to about 325 degrees Centigrade. One ordinarily skilled in the art will appreciate that the temperature of the polymer melt stream will be determined by several factors, including the kind of polymer flakes used, the energy supplied to the extruder screw, etc. As an example, PET is conventionally extruded at a temperature from about 260 degrees Centigrade to about 290 degrees Centigrade.

The hot polymer melt stream is thereafter immediately conditioned for subsequent formation into a blow molding preform, by cooling to a temperature at least 20 degrees Centigrade below the extruder discharge temperature. This cooling operation is effected by heat exchange between the hot polymer melt stream and a flowing stream of a liquid heat transfer medium, such as by a conventional quench oil heat transfer system utilizing a counter-flow, multi-channel heat exchanger.

This process step quickly cools the polymer melt stream, preserving the desirable properties of the polymer for the subsequent forming operations. The conditioning step according to the present inventive process is therefore superior to conventional methods of air-cooling, in mold cooling, or post molding cooling of the preform. Conventional apparatus and methods for cooling by means of quench oil systems are well known in the art.

Finally, the cooled polymer melt is formed into a blow molding preform. Methods and apparatus for preparing a preform from a polymer melt stream are well known in the art. The preform thus produced may thereafter be blow molded by conventional techniques to form a plastic container.

The invention is more easily comprehended by reference to the specific embodiments recited hereinabove, which are representative of the invention. It must be understood, however, that the specific embodiments are provided only for the purpose of illustration, and that the invention may be practiced other than as specifically set forth without departing from its spirit and scope.

What is claimed is:

1. A process for preparing a blow molding preform, comprising:
melting polymer flakes in a plasticating screw extruder, to prepare a homogeneous stream of hot polymer melt at the discharge of the extruder;
cooling the polymer melt stream to a temperature at least 20 degrees Centigrade below the extruder discharge temperature, by heat exchange with a liquid heat transfer medium; and
forming the cooled polymer melt into a blow molding preform.

2. The process for preparing a blow molding perform according to claim 1, wherein the polymer comprises polyethylene terephthalate, polyolefin, polyester, polyamide, acrylonitrile acid ester, vinyl chloride, or a derivative, blend, or a copolymer thereof.

3. The process for preparing a blow molding perform according to claim 2, wherein the polymer comprises polyethylene terephthalate.

4. The process for preparing a blow molding perform according to claim 1, wherein the polymer flakes comprise an average mean particle size from about ⅛ to about ¾ inch.

5. The process for preparing a blow molding perform according to claim 1, wherein the temperature of the polymer melt at the discharge of the extruder ranges from about 225 degrees Centigrade to about 325 degrees Centigrade.

6. The process for preparing a blow molding perform according to claim 5, wherein the temperature of the polymer melt at the discharge of the extruder ranges from about 260 degrees Centigrade to about 290 degrees Centigrade.

7. A process for preparing a blow molding preform, comprising:
melting polymer flakes, comprising polyethylene terephthalate, polyolefin, polyester, polyamide, acrylonitrile acid ester, vinyl chloride, or a derivative, blend, or a copolymer thereof, in a plasticating screw extruder, to prepare a homogeneous stream of hot polymer melt at the discharge of the extruder, the temperature of the polymer melt at the discharge of the extruder ranging from about 225 degrees Centigrade to about 325 degrees Centigrade;
cooling the polymer melt stream to a temperature at least 20 degrees Centigrade below the extruder discharge temperature, by heat exchange with a liquid heat transfer medium; and
forming the cooled polymer melt into a blow molding preform.

8. The process for preparing a blow molding perform according to claim 7, wherein the polymer comprises polyethylene terephthalate.

9. The process for preparing a blow molding perform according to claim 7, wherein the temperature of the polymer melt at the discharge of the extruder ranges from about 260 degrees Centigrade to about 290 degrees Centigrade.

10. A process for preparing a blow molding preform, comprising:
melting polymer flakes, comprising polyethylene terephthalate, in a plasticating screw extruder, to prepare a homogeneous stream of hot polymer melt at the discharge of the extruder, the temperature of the polymer melt at the discharge of the extruder ranging from about 260 degrees Centigrade to about 290 degrees Centigrade;
cooling the polymer melt stream to a temperature at least 20 degrees Centigrade below the extruder discharge temperature, by heat exchange with a liquid heat transfer medium; and
forming the cooled polymer melt into a blow molding preform.
